(19) United States
(12) Patent Application Publication
(10) Pub. No.: US 2003/0131889 A1
(43) Pub. Date: Jul. 17, 2003

(54) Pilot poppet type pressure control valve

(76) Inventor: Jin Wook Kim, Namyang-dong (KR)

Correspondence Address: HARNESS, DICKEY & PIERCE, P.L.C., P.O. BOX 828, BLOOMFIELD HILLS, MI, 48303, US

(21) Appl. No.: 10/044,548

(22) Filed: Jan. 11, 2002

(51) Int. Cl. F16K 31/12

(52) U.S. Cl. 137/491

(57) ABSTRACT

The present invention relates to a pilot poppet type pressure control valve capable of discharging a part of a fluid for thereby constantly maintaining a pressure of a high pressure chamber when the pressure of the high pressure chamber exceeds a certain level. In the pilot poppet type pressure control valve according to the present invention, a discharging port capable of discharging a fluid of a high pressure chamber includes an inner diameter which is gradually increased in a downstream direction for preventing an instant pressure decrease based on the opening by a pilot poppet when the pressure of a high pressure chamber exceeds a certain level. Therefore, in the present invention, it is possible to decrease a vibration and noise based on the discharge of a high pressure fluid based on the inventive construction of the discharging port. In addition, it is possible to process the discharging port at one time using a programmed NC lathe.

### BACKGROUND OF THE INVENTION

1. Field of the Invention

The present invention relates to a pilot poppet type pressure control valve capable of discharging a part of fluid in the case that a pressure of a fluid in a high pressure chamber exceeds a certain level, and in particular to a pilot poppet type pressure control valve which is capable of discharging a part of a fluid in a high pressure chamber by opening a flow path to an elastically supported pilot poppet in the case that a pressure of a fluid in a high pressure chamber exceeds a certain level.

2. Description of the Background Art

FIG. 4 is a cross-sectional view illustrating a conventional pilot poppet type pressure control valve.

As shown therein, the conventional pilot poppet type pressure control valve includes a main poppet 3 which reciprocates in a poppet 2 fixedly inserted in a front end of a sleeve 10 for opening and closing a discharging flow path which connects a high pressure chamber H and a low pressure chamber L, a pilot poppet 6 which is elastically supported by a first elastic member 7 in an interior in the front end side of a seat 5 engaged to a rear portion of the poppet 2 and is forwardly and backwardly moved for opening and closing a discharging port between a back pressure chamber B and an intermediate chamber M, and a piston 1 which reciprocates in a forward and backward direction with respect to the main poppet 3 and is elastically supported by a second elastic member 4 having an elastic coefficient smaller than the first elastic member 7 and forms a an orifice which connects the high pressure chamber H and the back pressure chamber B formed in the front and rear portions of the main poppet 3. In the above construction, the intermediate chamber M is connected to the low pressure chamber L through a discharging hole 13 formed in the seat and a discharging flow path 14 formed between the sleeve 10 and the poppet 2.

In the conventional pilot poppet type pressure control valve, in the case that the pressure of the high pressure chamber H exceeds a certain set range, the pilot poppet 6 is minutely moved backwardly by the pressure of the back pressure chamber B and opens the discharging port 12 formed between the back pressure chamber B and the intermediate chamber M, so that the fluid of the back pressure chamber B is discharged to the low pressure chamber L through the intermediate chamber M and the discharging flow path 14 and then the back pressure of the back pressure chamber B is decreased. Next, the piston 1 is moved in the direction of the seat 5 by the high pressure of the high pressure chamber H and is moved also by touching the pilot poppet 6 so that the discharging port 12 is more widely opened. Therefore, the back pressure of the back pressure chamber B is more lowered and the orifice 1a of the piston 1, which is an inner connecting path from the high pressure chamber H to the back pressure chamber B, is blocked by the pilot poppet 6 so that a high pressure fluid is no more transferred to the back pressure chamber B. Since the pressure difference between the high pressure chamber H and the back pressure chamber B is greater than the pressure difference reached at front and back surfaces of the stopped main poppet 3, the main poppet 3 is moved in the direction of the seat 5 by the high pressure of the high pressure chamber H and opens the discharging port 11 of the poppet 2 so that a high pressure fluid of the high pressure chamber H is discharged to the low pressure chamber L and the pressure of the high pressure chamber H does not exceed a certain set pressure range. In addition, in the case that the pressure of high pressure chamber H is decreased to a set range, the pilot poppet 6 is returned by an elastic force of the first elastic member 7 for thereby closing the discharging port 12 of the back pressure chamber B. The fluid of the high pressure chamber H is flown in through the orifice la of the piston 1, and the pressure of the back pressure chamber B is increased. The main poppet 3 is returned to an origin position by the pressure of the back pressure chamber B for thereby closing the discharging port 11 of the high pressure chamber H formed in the poppet 2, so that the pressure of the high pressure chamber H is decreased to a set range.

As described above, in the conventional pilot poppet type pressure control valve, in the case that the pressure of the high pressure chamber H exceeds a set range, the discharging flow paths 12, 13 and 14 and the discharging flow path 11 are opened for thereby discharging the high pressure fluid of the high pressure chamber. In the case that the above pressure is decreased to a set range, the flow paths 11, 12, 13 and 14 are closed for thereby preventing the high pressure fluid from being discharged, so that the pressure of the high pressure chamber H is set within a set range.

In the conventional pilot poppet type pressure control valve, the inner diameter of the discharging port 12 of the back pressure chamber B formed in the front end of the seat 5 is increased in the direction of the lower portion for effectively discharging the fluid of the back pressure chamber B. The inner surface of the same is processed by a special form tool or a drill machine. Therefore, as shown in FIGS. 5 and 6, when seeing in the vertical cross section direction, since the inner diameter of the same has a corner portion “e” in the direction of the lower portion and is formed in a non-linear shape, as shown in FIG. 7, the pressure is quickly decreased in the corner portion “e” when the high pressure is discharged. Therefore, when the high pressure fluid discharged from the high pressure chamber H passes through the corner portion “e”, the forms in the fluid are destroyed during the fluid discharging process for thereby generating a larger vibration and noise.

In addition, in the conventional pilot poppet type pressure control valve, since the discharging port 12 of the pilot poppet 6 which has a very low work process due to an accurate process is processed by a few times using other special tools each having different processing speed, the processing time and cost required for the process of the discharging port 12 are increased, so that the fabrication cost is increased.

### SUMMARY OF THE INVENTION

Accordingly, it is an object of the present invention to provide a pilot poppet type pressure control valve which is capable of processing a discharging port which discharges a high pressure fluid at one time using a programmed NC lathe and implementing a very small vibration and noise which occur due to a high pressure fluid discharge when a fluid of a high pressure chamber is discharged in the case that the pressure of the high pressure chamber exceeds a certain level.

In order to overcome the above objects, there is provided a pilot poppet type pressure control valve in which a discharging port of a back pressure chamber which is opened and closed by a pilot poppet has an inner diameter which is gradually increased in the downstream direction for preventing an instant pressure decrease of the fluid which is discharged wherein the pilot poppet type pressure control valve includes a pilot poppet which has a boundary between a high pressure chamber and a back pressure chamber, is elastically supported by a first elastic member, reciprocates based on an interrelationship between a pressure of the back pressure chamber with respect to the pressure of the high pressure chamber and an elastic force of a first elastic member for thereby opening and closing the discharging port of the back pressure chamber, and a main poppet which is elastically supported by at the second elastic member in the discharging port of the back pressure chamber, reciprocates based on an interrelationship between a pressure of the high pressure chamber and a pressure of the back pressure chamber and opens and closes the discharging port of the high pressure chamber wherein the pilot poppet seals the discharging port of the back pressure chamber by a supporting force of the first elastic member when the pressure of the high pressure chamber is below a set pressure level, and the discharging flow path of the high pressure chamber is closed by the main poppet to which the back pressure of the back pressure chamber is applied, and the pilot poppet opens the discharging flow path of the high pressure chamber to the main poppet to which the pressure of the high pressure chamber is applied as the pilot poppet opens the discharging port by the pressure of the high pressure chamber when the pressure of the high pressure chamber exceeds a set pressure level, an improved pilot poppet type pressure control valve in which

An inner surface of the discharging port of the back pressure chamber has a circular longitudinal section structure.

The pilot poppet is closely contacted with an inner surface of the discharging port for thereby sealing the discharging port as a sealing portion having an outer surface which has an outer diameter gradually increased.

There is further provided a piston which reciprocates in the main poppet in a forward and backward direction, is elastically supported by a second elastic member together with the main poppet and opens the pilot poppet when the piston is backwardly moved by a pressure of the high pressure chamber.

The piston includes an orifice formed in the interior of the piston for guiding a fluid of the high pressure chamber to the back pressure chamber.

### BRIEF DESCRIPTION OF THE DRAWINGS

The present invention will become better understood with reference to the accompanying drawings which are given only by way of illustration and thus are not limitative of the present invention, wherein;

FIG. 1 is a cross-sectional view illustrating a pilot poppet type pressure control valve according to the present invention;

FIG. 2 is an enlarged view of the portion 11 of FIG. 1;

FIG. 3 is a view illustrating a flow of a high pressure fluid discharged by a pilot poppet type pressure control valve according to the present invention;

FIG. 4 is a cross-sectional view illustrating a conventional pilot poppet type pressure control valve;

FIG. 5 is an enlarged cross-sectional view illustrating an example of a discharging port adapted to a conventional pilot poppet type pressure control valve;

FIG. 6 is an enlarged cross-sectional view illustrating another example of a discharging port adapted to a conventional pilot poppet type pressure control valve; and

FIG. 7 is a view illustrating a flow of a high pressure fluid discharged by a conventional pilot poppet type pressure control valve.

### DETAILED DESCRIPTION OF THE PREFERRED EMBODIMENTS

The preferred embodiments of a pilot poppet type pressure control valve according to the present invention will be explained with reference to the accompanying drawings.

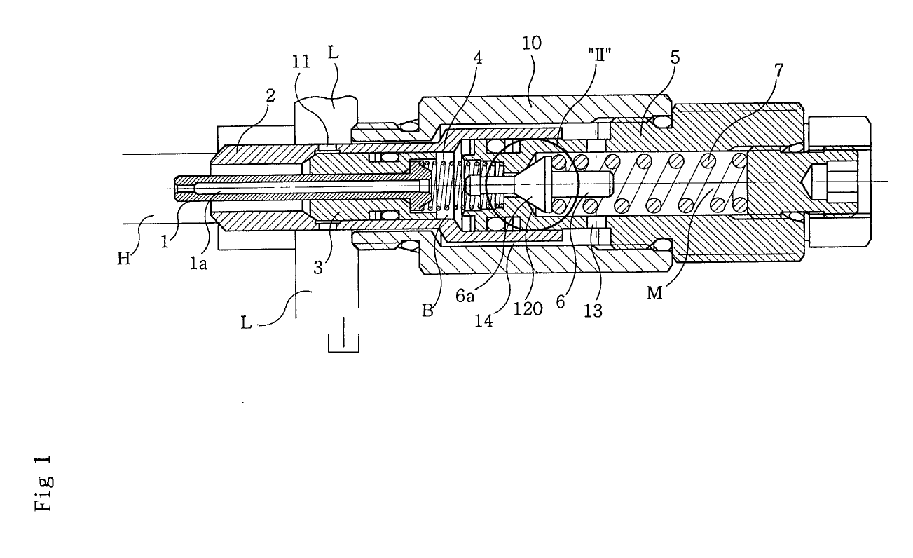

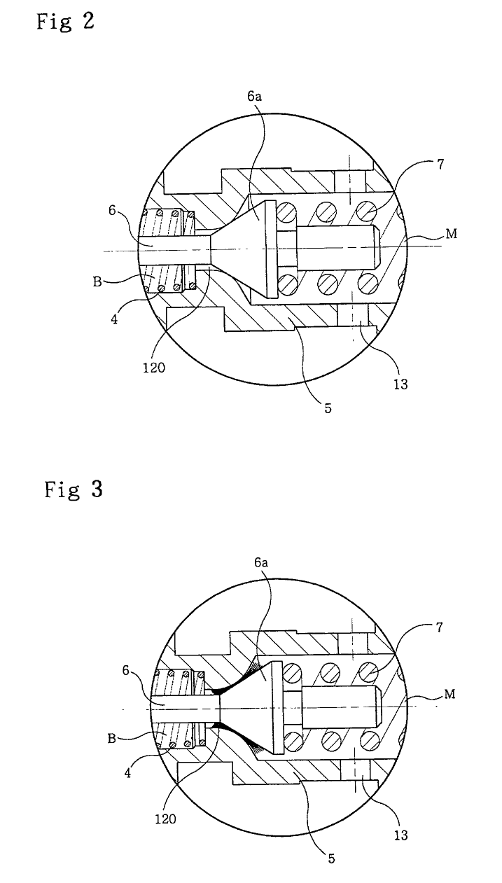

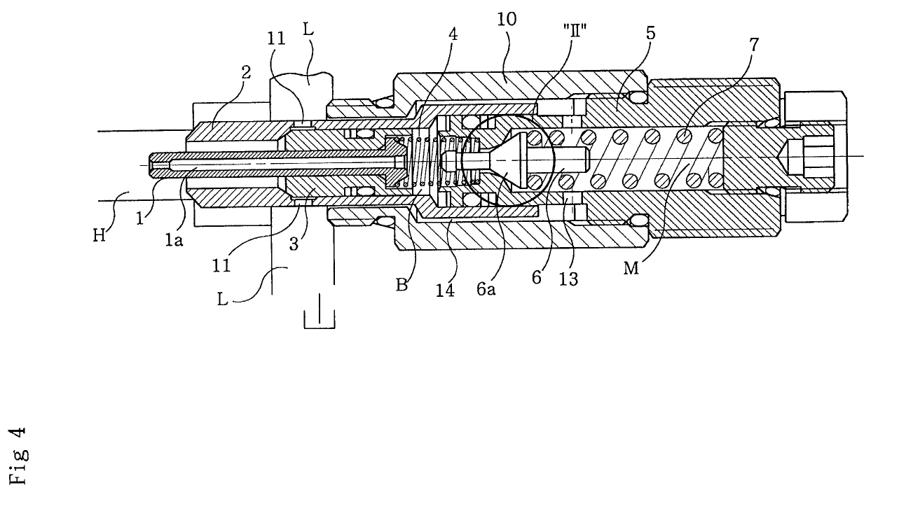

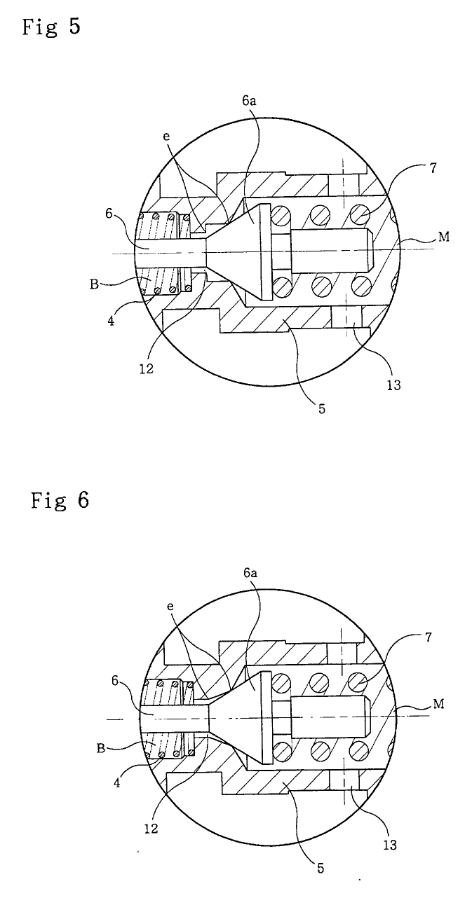

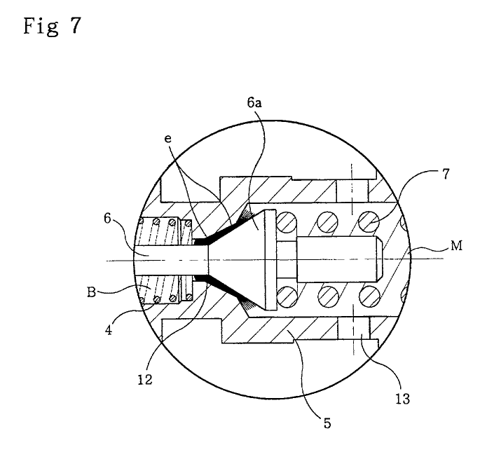

FIG. 1 is a cross-sectional view illustrating a pilot poppet type pressure control valve according to the present invention, and FIG. 2 is an enlarged view of the portion 11 of FIG. 1.

As shown therein, the pilot poppet type pressure control valve according to the present invention includes a hollow which is engaged to a front end of a sleeve 10, separates into a high pressure chamber H and a low pressure chamber L, and includes a discharging port 11 which connects the high pressure chamber H and the low pressure chamber L, a main poppet 3 which reciprocates in the poppet 2 for opening and closing the discharging port 11 of the poppet 2, a seat 5 which is engaged to a rear portion of the poppet 2 and forms a back pressure chamber B behind the main poppet 3 and an intermediate chamber M connected with the back pressure chamber B through the discharging port 120 in the rear portion, a pilot poppet 6 which is elastically supported by a first elastic member 7 in the intermediate chamber M of the seat 5 and reciprocates in the forward and backward directions for thereby opening and closing the discharging port 120, and a piston 1 which reciprocates in the forward and backward directions in the main poppet 3, is elastically supported by a second elastic member 4 having a smaller elastic coefficient compared to the first elastic member 7 and forms an orifice la which connects the high pressure chamber H and the back pressure chamber B formed in the front and rear portions of the main poppet 3.

In the above constructions, the intermediate chamber M is connected with the low pressure chamber L through the discharging hole 13 formed in the seat 5 and the discharging flow path 14 formed along the gap between the sleeve 10 and the poppet 2. In particular, as shown in FIG. 2 which is an enlarged view of the portion 11 of FIG. 1, the discharging port 120 of the back pressure chamber B formed in the intermediate portion of the seat 5 is formed in a conical shape in which the inner diameter of the same is gradually increased in the downstream direction, so that it has a circular curbed surface when seeing in the vertical cross-sectional direction. The discharging port 120 which is processed in a circular shape in its inner surface is processed by one time by the programmed NC lathe.

The pilot poppet 6 which seals the discharging port 120 includes a sealing portion 6a in which an outer diameter of the same is gradually increased in the downstream direction to correspond with the conical shape of the discharging port 120, so that the surface of the sealing portion 6a is closely contacted with the inner surface of the discharging port 120 for thereby effectively sealing the discharging port 120.

The operation of the pilot poppet type pressure control valve according to the present invention will be explained. In the present invention, the pressure of the high pressure chamber H is constantly maintained.

In the case that the pressure of the high pressure chamber H exceeds a set range and is increased, namely, in the case that the pressure of the high pressure chamber H is larger than the sum of the back pressure of the back pressure chamber B and the elastic support force of the second elastic member 4, the front end of the pilot poppet 6 is pushed by the pressure of the back pressure chamber B and pushes the front end of the pilot poppet, so that the sealing portion 6a of the pilot poppet 6 is distanced from the discharging port 120 for thereby opening the discharging port 120 of the back pressure chamber B. The fluid of the back pressure chamber B is flown through the intermediate chamber M, the discharging hole 13 and the discharging flow path 14 and is discharged to the low pressure chamber L, so that the pressure of the back pressure chamber B is decreased, and the piston 1 and the pilot poppet 6 are moved by touching each other, and the pressure difference between the high pressure chamber H and the back pressure chamber B is increased. Therefore, the main poppet 3 is moved to the seat 5 by a high pressure of the high pressure chamber H for thereby opening the discharging port 11 of the poppet 2. The high pressure fluid of the high pressure chamber H is discharged to the low pressure chamber L through the discharging port 11 of the poppet 2, so that the pressure of the high pressure chamber H is decreased.

Thereafter, when the pressure of the high pressure chamber H is decreased to a set level, namely, when the pressure of the same is decreased below the elastic force of the first elastic member 7, the pilot poppet 6 is returned by an elastic force of the first elastic member 7 for thereby closing the discharging port 120 of the back pressure chamber B. The fluid of the high pressure chamber H is flown into the back pressure chamber B through the orifice la of the piston 1, so that the pressure of the back pressure chamber B is increased. As the pressure of the back pressure chamber B is increased, the main poppet 3 is returned to an origin position by the pressure of the back pressure chamber B and the elastic force of the second elastic member 4 for thereby closing the discharging port 11 of the poppet 2. Therefore, the fluid of the high pressure chamber H is not discharged, and the pressure of the high pressure chamber H is not decreased to a set range.

In the operation of the pilot poppet type pressure control valve, when the pilot poppet 6 is opened due to an increase of pressure of the high pressure chamber H, and the high pressure fluid of the back pressure chamber B is discharged to the intermediate chamber M through the discharging pot 120 of the back pressure chamber B, the smoothly curved inner surface of the discharging port 120 decreases the instant pressure decrease of the fluid for thereby preventing a generation and destroy of the foams in the fluid, so that the vibration and noise due to the discharge of the high pressure fluid are decreased compared to the conventional pilot poppet type pressure control valve.

In the pilot poppet type pressure control valve according to the present invention, in the case that the high pressure fluid of the back pressure chamber is discharged through the discharging port due to the opening of the pilot poppet based on the increase of the pressure of the high pressure chamber, a smoothly curved inner surface of the discharging port prevents an instant pressure decrease of the fluid for thereby preventing a generation and destroy of the foams of the fluid. Therefore, in the present invention, it is possible to decrease a vibration and noise due to the discharge of the high pressure fluid. In addition, it is possible to improve the environment of work.

In the case of the pilot poppet pressure control valve according to the present invention, since an inner surface of the discharging port is processed by one time using a programmed NC lathe, the accuracy of the processing portion is increased, and the processing cost is decreased.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a pilot poppet type pressure control valve which includes a main poppet which has a boundary between a high pressure chamber and a back pressure chamber, is elastically supported by a second elastic member, reciprocates based on an interrelationship between a pressure of the back pressure chamber with respect to the pressure of the high pressure chamber and an elastic force of a second elastic member for thereby opening and closing a discharging flow path of the high pressure chamber, and a pilot poppet which is elastically supported by at the first elastic member in the discharging port of the back pressure chamber, reciprocates based on an interrelationship between a pressure of the back pressure chamber and an elastic force of the first elastic member and opens and closes the discharging port of the back pressure chamber wherein the pilot poppet seals the discharging port of the back pressure chamber by a supporting force of the first elastic member when the pressure of the high pressure chamber is below a set pressure level, and the discharging flow path of the high pressure chamber is closed by the main poppet to which the back pressure of the back pressure chamber is applied, and the pilot poppet opens the discharging flow path of the high pressure chamber to the main poppet to which the pressure of the high pressure chamber is applied as the pilot poppet opens the discharging port by the pressure of the high pressure chamber when the pressure of the high pressure chamber exceeds a set pressure level, an improved pilot poppet type pressure control valve in which the discharging port of the back pressure chamber which is opened and closed by the pilot poppet has an inner diameter which is gradually increased in the downstream direction for preventing an instant pressure decrease of the fluid which is discharged.

2. The valve of claim 1, wherein an inner surface of the discharging port of the back pressure chamber has a circular longitudinal section structure.

3. The valve of claim 1, wherein said pilot poppet is closely contacted with an inner surface of the discharging port for thereby sealing the discharging port as a sealing portion having an outer surface which has an outer diameter gradually increased.

4. The valve of claim 1, further comprising a piston which reciprocates in the main poppet in a forward and backward direction, is elastically supported by a second elastic member together with the main poppet and opens the pilot poppet when the piston is backwardly moved by a pressure of the high pressure chamber.

5. The valve of claim 4, wherein said piston includes an orifice formed in the interior of the piston for guiding a fluid of the high pressure chamber to the back pressure chamber.
